(19) United States
(12) Patent Application Publication
(10) Pub. No.: US 2006/0218231 A1
(43) Pub. Date: Sep. 28, 2006

(54) Direct point-to-point communications between applications using a single port

(75) Inventor: Bradford C. Davis, Erie, CO (US)

Correspondence Address: BAKER BOTTS L.L.P., 2001 ROSS AVENUE, SUITE 600, DALLAS, TX, 75201-2980, US

(73) Assignee: Computer Associates Think, Inc., Islandia, NY (US)

(21) Appl. No.: 10/890,432

(22) Filed: Jul. 12, 2004

Related U.S. Application Data
(60) Provisional application No. 60/486,596, filed on Jul. 11, 2003.

(51) Int. Cl. G06F 15/16

(52) U.S. Cl. 709/205

(57) ABSTRACT

A communication method and system that allows a remote application to reside on any node in an enterprise and to communicate with other remote applications in any node in the enterprise across the network, linking local applications on these nodes with one another. In one embodiment, the remote applications use a single port.

### CROSS-REFERENCE TO RELATED APPLICATIONS

This application claims the benefit of U.S. Provisional Patent Application No. 60/486,596 entitled SYSTEM AND METHOD FOR STANDARDIZING CLOCKS IN A HETEROGENEOUS NETWORKED ENVIRONMENT filed on Jul. 11, 2003, the entire disclosure of which is incorporated herein by reference.

### TECHNICAL FIELD

This application relates to client-server communications in computer systems.

### BACKGROUND

In TCP/IP programming, a port or a logical connection is used by a client program to specify a particular server program on a computer in a network with which it wants to communicate. For example, the Web protocol, Hypertext Transfer Protocol has a port with preassigned number, which is a “well-known port.” Other application processes are given port numbers dynamically for each connection. Thus, when a server program initially is started, it binds to its designated port number and any client program that wants to use that server must request to bind to the designated port number. The present disclosure describes a system and method in which all applications may communicate using a single publicly known port.

### SUMMARY

System and method for direct point-to-point communications between applications using a single port is provided. The system in one aspect includes a first object for communicating with remote objects. The first object uses a single port interface and includes at least a sender and a receiver communicating with the remote objects using the single port interface. A second object for communicating with local objects includes at least a sender and a receiver communicating with the local object. In another aspect, the first object and the second object are an application daemon process running on a node. The sender and the receiver of the first object and the sender and the receiver of the second object are threads in one aspect. The communicating in one aspect is event-driven.

The method in one aspect includes providing a first object for communicating with remote objects, the first object using a single port interface and comprising at least a sender and a receiver communicating with the remote objects using the single port interface, and providing a second object for communicating with local objects, the second object comprising at least a sender and a receiver communicating with the local object.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a schematic diagram illustrating the application daemons running on several nodes.

FIG. 2 is a block diagram illustrating components for moving arbitrary objects between threads.

FIG. 3 is a block diagram illustrating components for moving arbitrary objects between processes on the same node.

### DETAILED DESCRIPTION

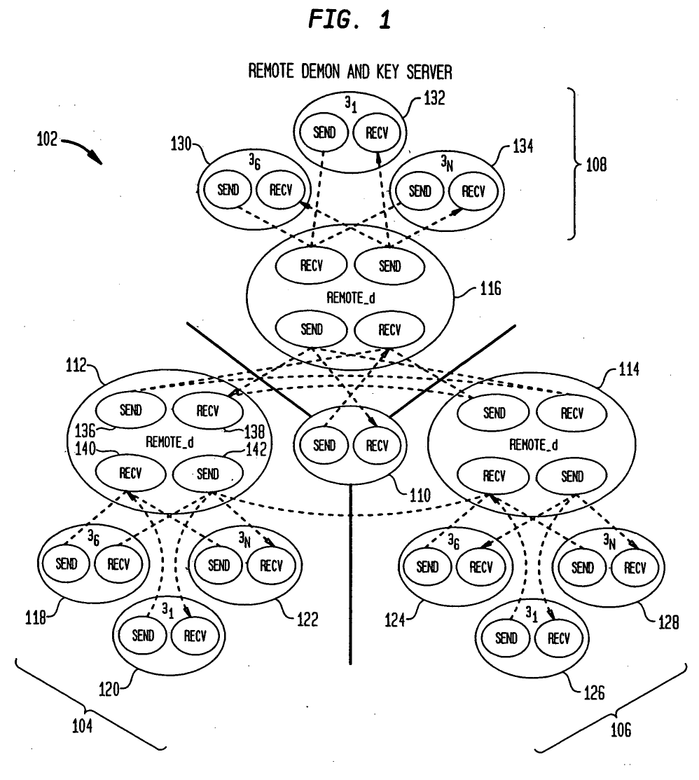

The method and system of the present disclosure in one embodiment provides an application daemon that runs in the background and serves as a single port interface in an enterprise's network. FIG. 1 is a schematic diagram illustrating the application daemons running on several nodes. FIG. 1 shows four nodes 104, 106, 108, and 110. For example, node 104 may be Solaris™ 2.6 and node 106 may be LinuX™ 7.2. The node 110 represents a key server.

In one aspect, one application daemon 112, 114, 116 runs on each node 104, 106, 108 respectively, in an enterprise 102. All applications or processes (118, 102, 122; 124, 126, 128; 130, 132, 134) running on a node (104; 106; 108 respectively) may communicate with one another through the application daemon (112; 114; 116 respectively) running on that node. Similarly, all applications 118, 120, 122 running on a node (first node) 104 may communicate with applications 124, 126, 128 running on another node (second node) 106 in a network 102 by communicating through the application daemon 112 running on the first node 104, which in turn communicates with the application daemon 114 running on the second node 106. The application daemon 114 running on the second node 106 then communicates to the applications running 124, 126, 128 on the second node 106.

In one embodiment, an application daemon of the present disclosure is client server application. In one embodiment, the application comprises four primary thread (for example, 136, 138, 140, 142) and a number of subordinate threads and is symmetric. In one embodiment, there are two server objects. One server object accepts connections from other remote application daemons residing on nodes through the enterprise. The second server object accepts connections from the local applications running on that particular node.

Each server object can dispatch and send messages in a similar manner via an array of client objects. One array of client objects dispatches to the corresponding remote application daemons through the enterprise. A second array of client objects dispatches to the corresponding applications on that particular node. In one embodiment, references to the origin application identifier, origin host, destination host, and destination application identifier are used for dispatching.

In one embodiment, the system and method of the present application provides the following functionalities for performing network communications: moving arbitrary objects between threads; moving arbitrary objects between processes on the same node; moving arbitrary objects between processes across the network between like operating systems; moving arbitrary objects between processes across the network where the processes are running on different operating systems.

In one embodiment, objects are moved between threads in an event driven manner. In the event driven manner, the arrival of the event may be realized in the destination thread at a point where the destination thread can wait while consuming the minimal CPU possible until the object is available. This is the notion of ‘event driven’ versus a polling algorithm where the destination thread continuously queries the source supplying the object for its readiness. In addition, data contention for the shared object is fully anticipated for threaded applications running in multi-cpu environment.

In one embodiment, the system and method of the present application uses the application space on top of the known TCP/IP and socket layers. The TCP/IP seven layer protocol layer accordingly is preserved. The socket layer is shared between the application and the operating system. Above the socket layer is a space referred to herein as the application space. It is in this application space where the present application may run.

The present application in one embodiment employs a canonical client server model, which will be described below. In one aspect, the well-known POSIX thread primitives may be used for Unix™ and Linux™ based implementations. In the system and method of the present application, the pthread primitives are encapsulated into a set of objects and their use has been made easier and robust. For the Microsoft™ platforms, the MS thread primitives are used and these are interfaced via the POSIX interface to localize the porting problem.

In addition, the system and method of the present application uses a number of other objects that make no reliance on POSIX, Microsoft™, Berkeley™ or any other existing standards.

The components of the present application will now be described in more detail. In one embodiment, the components are packaged and referred to as “Libmsg.”

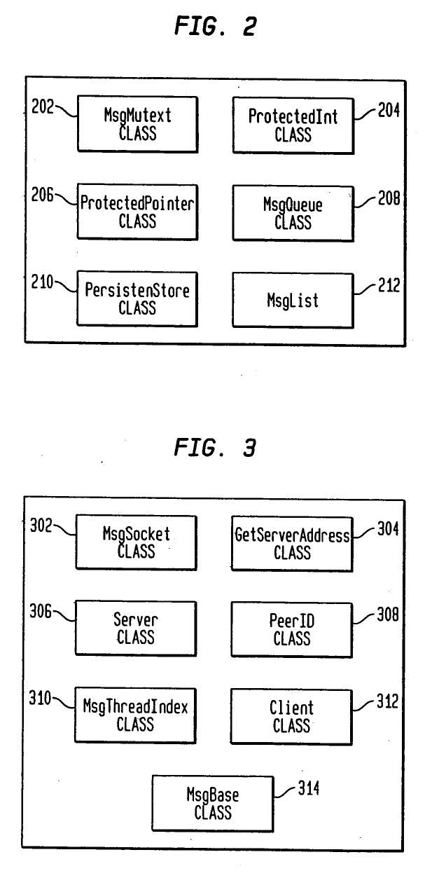

For moving arbitrary object between threads, the following is provided. FIG. 2 is a block diagram illustrating components for moving arbitrary objects between threads. A functionality provided is mutexing (from mutex or mutual exclusion). Mutexing means to protect an area of data that two or more processors may vie for simultaneously at runtime. While two or more processes may read the same data at the same time, they cannot be allowed to write to that address at the same time. If the application lets that happen the program may generally fault, that is, die, crash, cease to run.

The pthread library provides a number of primitives to accomplish mutexing, however, they are written in C and are not encapsulated. As such, the application programmer need to manage a number of variables to accomplish routine things that appear repeatedly in any application that deals with multi-threading. This makes writing threaded applications difficult and error prone.

However, these primitives lend themselves to an encapsulation that shields the application programmer from the cumbersome details required in the management of these variables. Encapsulation is a fundamental notion in the Object Oriented (“OO”) paradigm and one of its goals is to create a simple public interface which exposes only what is needed by the user of the object. The system and method of the present disclosure utilizes encapsulation. The following class is provided for encapsulating the mutex functionality.

The msgMutex Class (FIG. 2 202) may include:

Lock—attain a mutual exclusion Lock or get in line and wait if the lock is already held.

TryLock—return rather than block if the lock is already held.

Unlock—relinquish the lock.

ConditionedTimedWait—wait this duration in milliseconds or until signaled.

ConditionedWait—wait until signaled.

ClearPredicate—clear the predicate condition set by the application that is a precondition to ConditionTimedWait or a ConditionedWait.

Signal either wait method at which point they will unblock.

Broadcast a signal to a number of *Wait methods simultaneously.

For synchronization, the system and method of the present application uses asynchronous decomposition, which means taking the problem from the outset and segregating into its natural asynchronous components or threads. If a given loop breaks a rule, the iteration is too complex and needs to be broken down further. To break down a complex iteration means to find the largest contiguous subset of the iteration that satisfies the rules and put that in its own thread. Modern schedulers switch a thread in about 20 microseconds, a third of the time it takes to switch an application. That cost at runtime is insignificant.

Given the sufficient decomposition into asynchronous components, events are raised between threads, or interthread-signaling is performed. The following set of ‘protected’ classes whose characteristic includes that they safely operate on data between threads is provided. These are built on top of the msgMutex class and are defined and work as follows.

The ProtectedInt Class (FIG. 2 204) may include:

IsSetMethod interrogates a mutexed integer for a set/clear state.

Set the integer.

Clear the integer.

Increment the integer.

Decrement the integer.

Test if the integer IsPositive and return 1 or 0 accordingly.

Wait or block in the iteration until signaled.

Signal the Wait method so that it will unblock.

Return the Address of the integer.

Evaluate and return the value of the integer.

The second Protected class deals with addresses that may need to be modified and interrogated across threads.

The ProtectedPointer Class (FIG. 2 206) may include:

Set the address.

Evaluate the address.

With the classes provided above, the functionality of moving data between threads may be performed.

The msgQueue Class:

The msgQueue class 208 operates on a contiguous chunk of memory that is available to one or more threads for reading and writing. Data is stored in a protection fashion and individual elements or blocks of data can be inserted or deleted from any thread that has access to the msgQueue. The contiguous block of data is resized automatically as needed, up to a value in megabytes (default 8 MB) and this default can be reset at runtime. This class achieves the asynchronous decomposition. This class allows data to be moved in an event driven data manner between threads.

Enqueue—put an object at the end of the queue.

Dequeue—take an object off the head of the queue, block (wait) if empty.

Readqueue—peek the value at the head of the queue.

Rmelem—take the head element off the queue.

ReadBlock—peek a block from the head of the queue, block (wait) if empty.

RmBlock—take the bock from the head of the queue.

Unblock—unblock an empty queue.

Block—put this queue in a blocked state.

Entries—return the number of elements in the queue.

GetHeadPointer—return the address of the head element.

IsEmpty—return 1 empty, return 0 otherwise.

The msgQueue methods that introduce data into a thread are Dequeue, Readqueue, ReadBlock and GetHeadPointer. In one embodiment, data in the queue is not shared between the queue and the calling routine. The queue makes a deep copy of that object from the address passed to it by the caller on insertion and likewise loads a copy of queue owned element into the address passed by the caller on retrieval.

In one embodiment, these methods block when the queue is empty. Generally placed at the top of the iteration, they idle a particular iteration when no data is available. In one aspect, the POSIX and MS™ primitives are used in the system and method of the present application such that the scheduler does not bring into context a thread blocked because no data is available.

The arrival of data is an event that motivates the context switch of that thread by the scheduler and the processing of that data. In a well-constructed iteration, the complete iteration can generally be accomplished in the 20 milliseconds or so of time slice available to that context switch.

As noted previously, asynchronous decomposition does not restrict the number of destinations that can be targeted from a single thread. Any number of threads or processes may be dispatched from any number of points in a thread. Queues are routinely arrayed and dispatching a set of targets is done through an indexing scheme, where the targets are related to the indices of the array.

In one embodiment, a PersistentStore class 210 is provided that shares the same interface as the msgQueue and achieves the same functionality. In addition, in PersistentStore class 210, all elements are written and read from disk and are retrievable for subsequent runtime instances of the application. At the instantiation of this object, an identifier of path and filename are provided which locates the object, a flat binary file. This preserves data across runtime instances whereas data in the msgQueue is lost.

To understand the tradeoff in real terms, consider the TCP/IP model that assumes data in transport as volatile, but acknowledges receipt of data back to the sender. In this model, only the endpoints need to employ the PersistentStore and intermediate processes involved in the transport of data would use the msgQueue. Since the network is inherently volatile, and a chain is only as strong as its weakest link, only the source and destination processes need employ the PersistentStore. The originating process uses the PersistentStore and holds on to its data until the acknowledgement from the final destination process is received by the originator. The receiver can defend against duplicate data sent in the case of a lost acknowledgement.

Another class provided in the system and method of the present disclosure is the msgList class 212. The msgList 212 is similar to the msgQueue 208 in that it is used to move data between threads. It differs from the msgQueue 208 in that the notion of head and tail do not restrict the access to the list. Items are put on the list and chained in the order in which they are inserted but can be removed from any point in the list. In simple terms, a protected list class. The following methods are provided in the msgList class 212 in one embodiment:

Add—put an object on the list if object is unique.

Remove—object from list by matching the value of argument to key of element in list.

RemoveElem based on the address.

RegisterKey—register the location of this element in the object as a searchable key.

FindByKey—Find an object on the list based on the value of predetermined key element.

IsKeyRegistered—return one if true; zero otherwise.

IsEmpty—return one if true; zero otherwise.

Lock—preclude access to the list from any thread except that which holds this lock.

Unlock—open access to the list to any thread.

GetHeadPointer—return the head pointer of the list.

With the above defined classes, arbitrary objects may be moved between threads in an event driven fashion, in an application that has been decomposed into asynchronous components which then scales well, is intuitive and unencumbered by callbacks and signal handlers.

For moving arbitrary objects between processes on the same node, the canonical socket model using the AF_UNIX family of sockets is contemplated. FIG. 3 is a block diagram illustrating components for moving arbitrary objects between processes on the same node. The AF_UNIX family of sockets is used to move data between processes on the same machine, versus the AF_INET family that moves them across the network using TCP/IP, which is described below.

This is very efficient means of data transfer between processes on the same node with all the robustness of Berkeley sockets. In one embodiment, the implementation at the socket level is done via shared memory but the application is shielded from those details.

The canonical socket model distinguishes a client and server. In one aspect, servers listen for and accept clients on a known port made public to the clients and clients connect to the server. At the point a connection is established client and servers can talk to one another by means of send and recv. Send and recv are two examples of several calls, which can be used to achieve the sending and receiving of data. The classes described above may be used to transfer data between processes.

In one embodiment, the initial handshake of both the server and client are cleanly encapsulated and absolve the user of any knowledge of the socket model. The application developer need only know if he is a sender or receiver of data. If a sender is needed, a Client object is used. If an application is to receive data, a Server object is used. If an application wants to send and receive data, then both a Client and a Server object are used. These objects are detailed below with a number of intermediate objects that is developed to build the Client and Server. To instantiate the Client object, only the Server host and port need be known to the application. Similarly, the only information that the application supplies to the Server object is the port on which the Server is listening. This is encapsulation of the canonical socket model from the standpoint of the application developer and greatly simplifies the encoding of a full-fledged socket application.

In addition, the system and method of the present disclosure provides guaranteed message delivery (GMD). Data is sequenced and held until acknowledged and received in msgQueues. Since data is held in a msgQueue until acknowledged, data is not lost regardless of the state of the network or an outright loss due to catastrophic failure in the network infrastructure.

Further the system and method of the present disclosure provides automatic recovery. If the application containing the Server goes away, the Client will reconnect automatically when the Server object becomes available in a new process. Processes containing Client objects can reconnect as well with the destruction and re-instantiation of the Client object. However, Client side reconnection is not restricted to object destruction and re-instantiation.

In one embodiment, client and server are full peers. This means that automatic recovery happens from either side. If a Server is lost, the Clients quickly and automatically reconnect when the Server comes back. If a Client is lost, it can be brought back up and it will reconnect with the Server.

The system and method described provides fast transport. Data in msgQueues are evacuated in blocks up to 64K in size and uploaded on the receive side in similar blocks in a single function call. This takes advantage of the maximum ‘TCP window’ and reduces the overhead the layers under the application (socket and TCP/IP) need to move the application data.

The msgSocket Class:

In one embodiment, the msgSocket Class 302 is private to the SDK and though integral to workings of the public classes of Libmsg, it is not part of the public interface. Users of the SDK do not need to understand it, nor do they need to be aware of its existence. Note the two constructors.

msgSocket—server constructor calls the following methods.

CreateSocket—create and initialize the socket.

Bind—encapsulates the Berkeley “bind” function.

GetSockName—encapsulates the Berkeley “getsockname” function.

Listen—encapsulates the Berkeley “listen” function.

msgSocket—client constructor calls the following methods.

CreateSocket—create and initialize the socket.

Connect—encapsulates the Berkeley “connect” function.

The remaining methods of the msgSocket are private methods, which are not called from either constructor.

IsSckValid—is the object in good condition.

Accept—encapsulates the Berkeley “accept” function and is called only from the Server.

Send—encapsulates the Berkeley “send” function called from both Client and Server.

Receive—encapsulate the Berkeley “recv” function.

CloseSocket—encapsulates the system “close” function.

The GetServerAddress Class:

The GetServerAddress Class 304 is private to the SDK and though integral to workings of the public classes of Libmsg, it is not part of the public interface. Users of the SDK do not need to understand it, nor do they need to be aware of its existence.

The GetServerAddress Class 304 accesses the Berkeley “gethostbyname,” and populates the “hostent” structure. It is pulled from the msgSocket because it need not be called at the same frequency of the msgSocket. Gethostbyname is implemented as a thread, which is monitored with a msgMutex::ConditionedTimedWait, since the Berkeley call is known to hang.

IsValid—returns the condition of this object as 1/0.

GetHostByName—encapsulates, threads and times the potentially blocking Berkeley “gethostbyname.”

In one embodiment, the Server and Client objects are two pubic classes used to move objects between processes. The objects at this level do not care whether those objects are to move between two processes on the same machine, or between two processes on machines that are located on opposite sides of the planet. The mechanics of these objects is the same, regardless.

The Server Class:

The Server Class 306 owns several subordinate private objects. The Server constructor creates a limited Client object solely for the purpose of shutting down. The Berkeley “accept” is generally in a blocked state and a signal is not raised against it to unblock it in the event a shutdown is ordered. Therefore, to unblock the “accept” and allow the shutdown to proceed, a msgSocket::Connect is called.

The Server starts the AcceptClientsThread that starts a RecvThread for every Client object that seeks to connect with the Server. RecvThreads handle the incoming data and come and go for a variety of reasons. A Client that has been quiet in excess of the timeout; Clients that send an explicit breakSig and Clients that send data whose header does not conform to security protocol are dropped and the RecvThread terminates. The AcceptClientsThread persists for the life of the object.

Public:

IsValid—return 1 if object is in good condition; 0 otherwise.

Recv—called from application with a pointer to an address at which data will be copied, blocks if no data is available.

Recv_NoBlock—same as Recv but does not block in the event no data is available.

Shutdown—shutdown the various threads which may exist and destroy this object.

Private:

Client—a limited Client object existing only for the purposes of shutting down.

RecvService—do the msgSocket::Accept handle receive threads.

msgQueue—store data.

PeerId—enable the Server to keep track of message sequences from incoming Clients.

msgThreadIndex—enable the Server to keep track of simultaneous RecvThreads.

AcceptClientsThread—block on msgSocket::Accept, return a socket when Client connects.

RecvThread—The work of the Server object is done in the RecvThread. there is a RecvThread for every incoming Client object that is sending data. Clients that quit sending data are timed out in accordance with a variable set in the environment. Clients can also set an explicit “breakSig” that will terminate the RecvThread. The RecvThread calls msgSocket::Receive, tests for the sequential integrity of the data, sends the acknowledgement to the appropriate Client and puts the data on the msgQueue.

The PeerId Class:

The PeerId 308 is private to the SDK and though integral to workings of the public classes of Libmsg, it is not part of the public interface. Users of the SDK do not need to understand it, nor do they need to be aware of its existence.

This object exists solely to support the Server object. Clients are identified by information in the headers of their incoming messages and the PeerId 308 is accessed to track the sequential integrity of the message from that Client. The sequential integrity of messages is the central component to the guaranteed message delivery and will be discussed further in the Client. But sequential integrity is important to the Server as well.

Clients hold messages in their respective msgQueues until they receive an acknowledgement. The Server sends the acknowledgement on the condition that the message meets security protocol and the message is deemed in good condition. However, it is possible that the Client may have resent a message because it failed to receive an acknowledgement on a previously sent message. In other words, the Server received the message but the Client did not receive the acknowledgement. The Server is able to defend against this, so that it does not enqueue the same message twice.

The PeerId 308 owns a msgList and a msgMutex object. The msgList stores an address and pid (process id) pair and the mutex is used internally to secure access to the object since more than a single RecvThread may generally contend for the PeerId.

Add—add this Client to the msgList of currently connected Clients.

Remove—this Client from the msgList of currently connected Clients.

GetPrevSeqno—get the previous sequence number for this Client.

ReviseSeqno—revise the sequence number for this Client.

The msgThreadIndex Class:

The msgThreadIndex Class 310 is private to the SDK and though integral to workings of the public classes of Libmsg, it is not part of the public interface. Users of the SDK do not need to understand it, nor do they need to be aware of its existence.

This object manages the indexing the array of RecvThreads that are currently in existence within the Server.

GetNextFreeIndex—get the next available (not in use) index counting from zero.

GetThreadIndex—get the index which was assigned to this thread.

SetThreadIndex—set this threads index to a value.

GetLastIndex—get the last index in use.

The Client Class:

The Client 312 is primary counterpart to the Server object defined above. Note the distinction between public and private objects and methods. Only the public methods are visible to users of the SDK. The private components are listed to enable a broader understanding of the Client object.

Public Methods:

IsValid—test the condition of the object return 1/0.

Send—application interface to send.

SendWaitForAck—application interface to send and wait for acknowledgement.

NinQ—return the number of elements in this msgQueue.

Private Methods and Objects:

GetServerAddress—get Server hostent struct information.

msgSocket—do the necessary client side socket work.

The msgSocket is constructed and destructed in the Client object for every reconnection. The Server terminates connections after a short duration of no incoming data. Sends from the Client which follow a delay exceeding that timeout fail, despite the pre-existing connection. The cost of a failed send is sub-millisecond and a new connection can be re-established between nodes on opposite coasts in less than half a second (and within 20 milliseconds on nodes in the same segment). Since data is safe in the msgQueue, this is a very efficient handshake mechanism that can be kept completely out of the application. This mechanism provides automatic recovery in the Client.

msgQueue (2)—one for outbound msgs and one for acks.

ProtectedPointer—protected address access between threads.

ProtectedInt—protected integer access between threads.

msgMutex (2)—general protection for areas of contention.

RecycleThread—recycle the ClientSendThread if it gets dropped.

ClientSendThread—does the work of the of the Client object. Peek the head element on the msgQueue, send it, receive the ack, remove the element

The msgBase Class:

An application developer can define a message object in any way desired. In one embodiment, that object is derived from msgBase 314, which puts a 48-byte header at the front of the user's object. The Client and Server objects interrogate this header, but the application need not look at it. The application developer may need to be aware that their object does derive from msgBase 314 as well as the fact that their data starts +48 bytes from the point of the object they have created from the msgBase class 314.

MsgBase 314 also provide methods that serve as good examples in how to deal with the endian problems that integer transport invites.

In one embodiment, none of the msgBase methods are public.

ToNetBaseAlignment—called from Client (send) side.

ToHostBaseAlignment—called from Server (recv) side.

SetElemsThisBlock—number of elements sent in this packet, maximize to 64K.

The above-described class components allow implementing an event driven applications that communicate between processes on the same node with capability for GMD, automatic recovery, and fast data transport.

For moving data between processes on different nodes, for example, connected by Ethernet, routers, TCP/IP, cable, fiber, etc., Berkeley sockets and TCP/IP layers may be utilized.

When the Libmsg application sees that the host value at time of the Server instantiation is other than “localhost” it uses the AF_INET family sockets in the msgSocket in lieu of the AF_UNIX family sockets (both of which are Berkeley constructs) and populates a variant hostent structure.

The same thing happens in the Client instantiation. Using the above-described components of Libmsg, event driven applications that communicate between processes on different nodes of the same operating system having capabilities for GMD, automatic recovery, and fast data transport, may be implemented.

For moving arbitrary objects between processes across the network where the processes are running on different operating systems, the system and method of the present disclosure provides a set of header files and static library or a shared object that compiles and links in particular environment. The public SDK interface is identical across the Unix variants, Linux, the Microsoft platforms, VMS, as/400 and MVS.

Porting issues are minimized in large part to the industry's use of the POSIX Draft 10 of pthreads and the universally accepted Berkeley sockets. Thus, using the components of Libmsg described above, event driven applications that communicate between processes on different nodes running a full variety of operating systems from Solaris 2.5.1, OSF 4.0d, AIX 4.3.2, HP 11, Linux 7.2, full range of Microsoft, VMS 6.2, as/400 may be implemented.

The system and method of the present disclosure may be implemented and run on a general-purpose computer. The embodiments described above are illustrative examples and it should not be construed that the present invention is limited to these particular embodiments. Although particular classes were provided as examples, it should be understood that the method and system disclosed in the present application may be implemented using different programming methodologies. Thus, various changes and modifications may be effected by one skilled in the art without departing from the spirit or scope of the invention as defined in the appended claims.

I claim:

1. A system for direct point-to-point communications between applications using a single port, comprising:
a first object for communicating with remote objects, the first object using a single port interface and comprising at least a sender and a receiver communicating with the remote objects using the single port interface; and
a second object for communicating with local objects, the second object comprising at least a sender and a receiver communicating with the local object.

2. The system of claim 1, wherein the first object and the second object are an application daemon process running on a node.

3. The system of claim 2, wherein the system further includes a plurality of nodes, each of the plurality of nodes running the application daemon process for communicating between the nodes.

4. The system of claim 1, wherein the sender and the receiver of the first object and the sender and the receiver of the second object are threads.

5. The system of claim 1, wherein the first object uses origin application identifier, origin host, destination host, destination application identifier, or combinations thereof for communicating.

6. The system of claim 1, wherein the second object uses origin application identifier, origin host, destination host, destination application identifier, or combinations thereof for communicating.

7. The system of claim 1, wherein the communicating is event-driven.

8. The system of claim 1, wherein the communicating is performed by at least one of moving objects between threads, moving objects between processes on the same node, moving objects between processes across the same operating systems, and moving objects between processes across different operating systems.

9. The system of claim 8, wherein the objects are moved in event-driven manner.

10. The system of claim 1, wherein the communicating is performed using application space on top of TCP/IP layers.

11. The system of claim 1, wherein the communicating is performed using application space on top of a socket layer.

12. The system of claim 4, wherein the threads are asynchronous.

13. A direct point-to-point communications method between applications using a single port, comprising:
providing a first object for communicating with remote objects, the first object using a single port interface and comprising at least a sender and a receiver communicating with the remote objects using the single port interface; and
providing a second object for communicating with local objects, the second object comprising at least a sender and a receiver communicating with the local object.

14. The method of claim 13, further including:
providing the sender and the receiver of the first object as threads; and
providing the sender and the receiver of the second object as threads.

15. The method of claim 13, further including:
providing the sender and the receiver of the first object as asynchronous threads; and
providing the sender and the receiver of the second object as asynchronous threads.

16. The method of claim 14, further including:
moving objects between the threads.

17. The method of claim 16, wherein the objects are moved in an event-driven manner.

18. A program storage device readable by machine, tangibly embodying a program of instructions executable by the machine to perform a direct point-to-point communications method between applications using a single port, comprising:
providing a first object for communicating with remote objects, the first object using a single port interface and comprising at least a sender and a receiver communicating with the remote objects using the single port interface; and
providing a second object for communicating with local objects, the second object comprising at least a sender and a receiver communicating with the local object.

19. The program storage device of claim 18, further including:
providing the sender and the receiver of the first object as asynchronous threads; and
providing the sender and the receiver of the second object as asynchronous threads.

20. The program storage device of claim 18, wherein the communicating is performed in an event-driven manner.
